(19) United States
(12) Patent Application Publication
(10) Pub. No.: US 2016/0377250 A1
(43) Pub. Date: Dec. 29, 2016

(54) VEHICLE LIGHTING FIXTURE

(71) Applicant: Stanley Electric Co., Ltd., Tokyo (JP)

(72) Inventor: Masafumi Ohno, Tokyo (JP)

(21) Appl. No.: 15/189,669

(22) Filed: Jun. 22, 2016

(30) Foreign Application Priority Data
Jun. 23, 2015 (JP) 2015-125313

(51) Int. Cl. F21S 8/10

(52) U.S. Cl. CPC F21S 48/1283; F21S 48/115; F21S 48/1721; F21Y 2115/10; F21Y 2105/16

(57) ABSTRACT

A vehicle lighting fixture can suppress light intensity variations in light distribution by a plurality of light sources and perform more precise light distribution control. The vehicle lighting fixture can include a plurality of LED elements that are arranged in vertical and left-right directions, and two projector lenses that are arranged in front of the plurality of LED elements and project light emitted from the plurality of LED elements forward. A front surface and a rear surface of the two projector lenses are surfaces formed by dividing a basic shape that is a continuous surface into a plurality of divided surfaces in an arrangement direction of the plurality of LED elements and rotating each of the divided surfaces so that a light source image formed by the plurality of LED elements can be widened in the arrangement direction.

This application claims the priority benefit under 35 U.S.C. §119 of Japanese Patent Application No. 2015-125313 filed on Jun. 23, 2015, which is hereby incorporated in its entirety by reference.

### TECHNICAL FIELD

The presently disclosed subject matter relates to a vehicle lighting fixture mounted on a vehicle, and more particularly to a vehicle lighting fixture including a plurality of light sources arranged in a predetermined direction.

### BACKGROUND ART

As vehicle lighting fixtures mounted on a vehicle, ones using an array of a plurality of light sources such as light-emitting diodes have heretofore been known (for example, see Japanese Patent Application Laid-Open No. 2001-266620 or US2001/019486A1 corresponding thereto). In particular, variable light distribution headlamps for changing light distribution according to the surrounding environment and the like have become prevalent recently. Vehicle lighting fixtures of this type are usually configured to use a large number of light-emitting diode capable of individual on/off control.

It is extremely difficult to arrange a plurality of light sources without a gap. If a plurality of light sources are simply turned on to emit light, the gaps between the light sources therefore produce dark portions in the light emission range, causing light intensity variations in the light distribution. If such a vehicle lighting fixture is used as a headlamp or a signal lamp, driving safety may be impaired because of a decrease in the driver's visibility, misrecognition of the driving situation, etc.

For example, a vehicle lighting fixture described in Japanese Translation of PCT Application) No. 2006-522440 (or US2006/198118A1 corresponding thereto) includes a light-transmitting chip cover that covers a large number of semiconductor light sources arranged on a substrate. The interior of the chip cover is filled with an additive material having a light scattering characteristic and/or a light conversion characteristic. Light from the semiconductor light sources is diffused by the additive material to suppress light intensity variations in the light distribution.

The vehicle lighting fixture described in Japanese Translation of PCT Application) No. 2006-522440 (or US2006/198118A1 corresponding thereto) utilizes the diffusion of light by the additive material, and the degree of diffusion is thus difficult to control. If such a vehicle lighting fixture is used as a variable light distribution headlamp, light from light sources in a lit state can enter the optical paths of light sources in an unlit state to hinder precise light distribution control.

### SUMMARY

The presently disclosed subject matter was devised in view of these and other problems and features in association with the conventional art. According to an aspect of the presently disclosed subject matter, a vehicle lighting fixture can suppress light intensity variations in the light distribution by a plurality of light sources and perform more precise light distribution control.

According to another aspect of the presently disclosed subject matter, a vehicle lighting fixture, having an optical axis in which light is emitted therefrom, can include: a plurality of light sources arranged in a predetermined arrangement direction orthogonal to the optical axis; and at least one projector lens that is arranged forward of the plurality of light sources along the optical axis and is configured to project light emitted from the plurality of light sources forward, wherein the at least one projector lens includes a rear surface and a front surface at least either one of which can be a surface formed by dividing a basic shape into a plurality of divided surfaces corresponding to the arrangement direction and rotating each of the divided surfaces so that a light source image formed by the plurality of light sources can be widened corresponding to the arrangement direction, the basic shape being a smooth continuous surface.

In the vehicle lighting fixture with the above-described configuration, the at least one surface can be divided into a plurality of divided surfaces with a line orthogonal to a direction corresponding to the arrangement direction in the optical axis, the line passing through a center of the surface, as a dividing line, and each of the divided surfaces can be rotated about the dividing line.

In the vehicle lighting fixture with any of the above-described configurations, the at least one surface can include a plurality of types of divided surfaces having respective different rotation angles.

In the vehicle lighting fixture with the above-described configuration, the at least one surface can include two types of divided surfaces that are an inner side and an outer side of the at least one surface, and either one of the two types of divided surfaces can have a rotation angle approximately three times that of the other.

In the vehicle lighting fixture with any of the above-described configurations, the plurality of light sources can be arranged in a matrix in two arrangement directions generally orthogonal to each other; the at least one projector lens can include at least two projector lenses that are juxtaposed in the optical axis; and the front surface of a projector lens on a rear side can be formed to correspond to one of the two arrangement directions, and the rear surface of a projector lens on a front side can be formed to correspond to the other of the two arrangement directions.

According to the presently disclosed subject matter, at least one of the rear and front surfaces of the projector lens(es), divided and rotated corresponding to the arrangement direction of the plurality of light sources, can be configured to widen the light source image formed by the plurality of light sources in the arrangement direction.

This can lessen the dark portions corresponding to the gaps between the plurality of light sources and, by extension, suppress light intensity variations in the light distribution. The mode of division and the mode of rotation of the at least one surface of the projector lens(es) can be appropriately adjusted for more precise light distribution control.

Consequently, light intensity variations in the light distribution by the plurality of light sources can be suppressed, and more precise light distribution control can be performed as well.

### BRIEF DESCRIPTION OF DRAWINGS

These and other characteristics, features, and advantages of the presently disclosed subject matter will become clear from the following description with reference to the accompanying drawings, wherein:

FIG. 1 is a sectional side view showing essential parts of a vehicle lighting fixture according to an exemplary embodiment and a modified example thereof;

FIG. 2 is a perspective view of an LED array;

FIGS. 3A and 3B are diagrams for describing a first projector lens according to the exemplary embodiment;

FIGS. 4A and 4B are diagrams for describing a second projector lens according to the exemplary embodiment.

FIGS. 5A, 5B, and 5C are graphs showing a light intensity distribution of a projection image formed by the vehicle lighting fixture according to a comparative example when the two projector lenses have basic shapes, FIG. 5A being a graph showing a light intensity distribution of a projected image on a virtual vertical screen, FIG. 5B being a graph showing the light intensity distribution in a left-right direction, and FIG. 5C being a graph showing the light intensity distribution in a vertical direction;

FIGS. 6A, 6B, and 6C are graphs showing a light intensity distribution of a projection image formed by the vehicle lighting fixture according to the exemplary embodiment, FIG. 6A being a graph showing a light intensity distribution of a projected image on a virtual vertical screen, FIG. 6B being a graph showing the light intensity distribution in a left-right direction, and FIG. 6C being a graph showing the light intensity distribution in a vertical direction;

FIGS. 7A and 7B are diagrams for describing a first projector lens according to the modified example of the exemplary embodiment;

FIGS. 8A and 8B are diagrams for describing a second projector lens according to the modified example of the exemplary embodiment;

FIGS. 9A, 9B, and 9C are graphs showing a light intensity distribution of a projection image formed by the vehicle lighting fixture according to the modified example of the exemplary embodiment, FIG. 9A being a graph showing a light intensity distribution of a projected image on a virtual vertical screen, FIG. 9B being a graph showing the light intensity distribution in a left-right direction, and FIG. 9C being a graph showing the light intensity distribution in a vertical direction;

FIGS. 10A and 10B are diagrams for describing a projection image formed when outer divided surfaces of the projector lenses have a rotation angle approximately three times that of inner divided surfaces; and

FIG. 11 is a table 1 showing the specifications of the two projector lenses 7 and 8.

### DESCRIPTION OF EXEMPLARY EMBODIMENTS

A description will now be made below to vehicle lighting fixtures of the presently disclosed subject matter with reference to the accompanying drawings in accordance with exemplary embodiments.

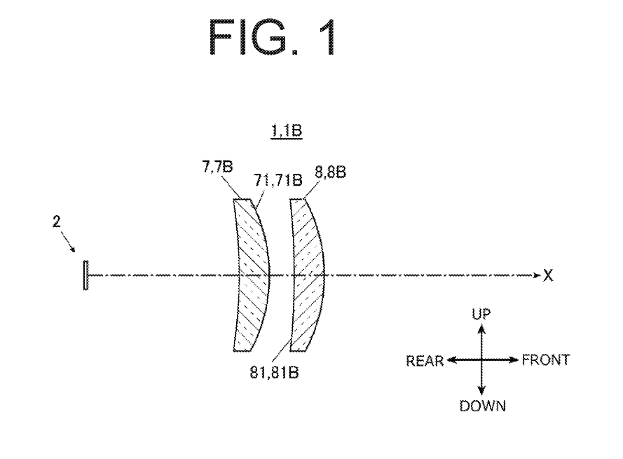

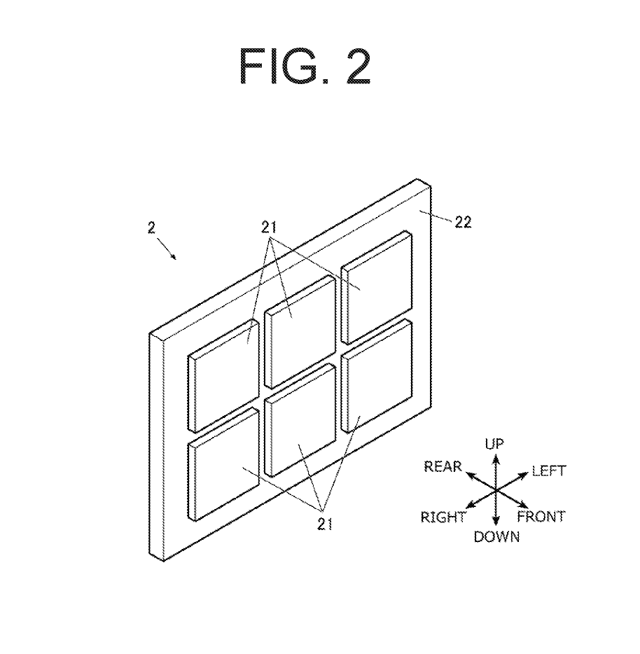

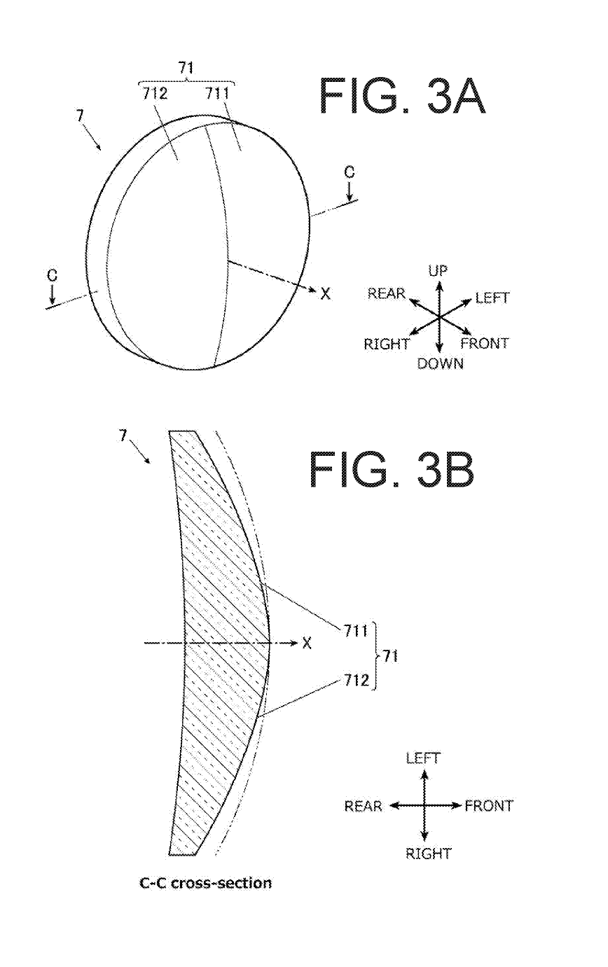

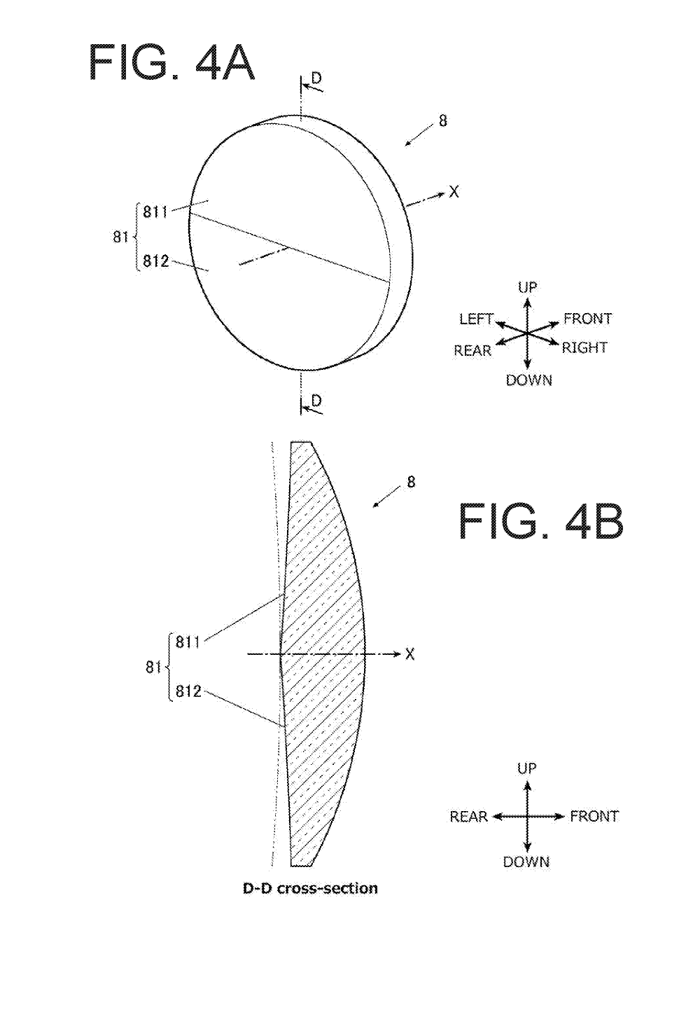

FIG. 1 is a sectional side view showing essential parts of a vehicle lighting fixture 1 according to the present exemplary embodiment. FIG. 2 is a perspective view of an LED array 2 included in the vehicle lighting fixture 1. FIGS. 3A, 3B, 4A, and 4B are diagrams for describing a first projector lens 7 and a second projector lens 8 (constituting the “at least one projector lens”) included in the vehicle lighting fixture 1. FIGS. 3A and 4A are perspective views. FIGS. 3B and 4B are sectional views taken along the lines C-C and D-D of FIGS. 3A and 4A, respectively.

The vehicle lighting fixture 1 can be mounted on a not-shown vehicle. In the present exemplary embodiment, the vehicle lighting fixture 1 can be a headlamp mounted on a front part of the vehicle.

Specifically, as shown in FIG. 1, the vehicle lighting fixture 1 can include a light-emitting diode (LED) array 2 and the two projector lenses 7 and 8. Such optical members can be arranged on an optical axis X extending in a front-rear direction of the vehicle.

As shown in FIG. 2, the LED array 2 can be configured to include a plurality (in the present exemplary embodiment, six) of LED elements 21 which can be mounted on a front surface of a flat plate-shaped substrate 22 orthogonal to the front-rear direction. The plurality of LED elements 21 can be arranged in a matrix of two rows and three columns with their respective light emitting surfaces forward.

In the present exemplary embodiment, each LED element 21 can have a size of approximately 1 mm square and be configured to emit a light beam of 200 lm. Each LED element 21 can be arranged to be vertically and laterally separated from adjoining ones with a gap of approximately 0.2 mm therebetween.

As shown in FIG. 1, the two projector lenses 7 and 8 (the at least one projector lens) can be configured to include the first projector lens 7 on the rear side (LED array 2 side) and the second projector lens 8 on the front side. The projector lenses 7 and 8 can be arranged adjacent to each other in the front-rear direction and arranged in front of the LED array 2. The two projector lenses 7 and 8 as a whole can have an object-side focal point near the LED array 2 and an image-side focal point far in front (in the present exemplary embodiment, approximately 25 m away from the lens in front), and project light emitted from the LED array 2 (plurality of LED elements 21) forward. Each of the two projector lenses 7 and 8 is a convex lens having a convex front surface.

In addition to projecting the light from the plurality of LED elements 21 forward, the two projector lenses 7 and 8 can also have a function of refracting the light in the arrangement directions of the plurality of LED elements 21 (i.e., vertical and left-right directions) to widen a light source image formed by the plurality of LED elements 21. Specifically, the two projector lenses 7 and 8 can have a basic shape for projecting the light from the plurality of LED elements 21. A front or rear surface of the basic shape can be deformed to widen the light source image formed by the plurality of LED elements 21.

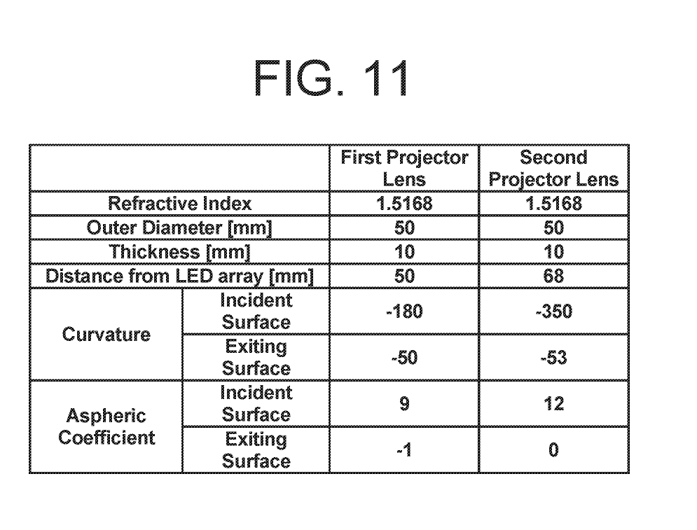

Table 1 as shown in FIG. 11 shows specifications of the basic shapes of the two projector lenses 7 and 8 according to the present exemplary embodiment. In Table 1, the “thickness” and “distance” are expressed by lengths on the optical axis X. The “distance from the LED array” refers to the distance from the LED array 2 to the rear surface (incident surface) of each projector lens 7 or 8.

Of the two projector lenses 7 and 8, the first projector lens 7 on the rear side, as shown in FIG. 3A, can include a front surface (exiting surface) 71 which can have a function of laterally widening the light source image.

As shown in FIG. 3B, the front surface 71 of the first projector lens 7 can be a surface formed by dividing a basic shape that is a smooth continuous surface (shape shown by the long dashed double-short dashed line in FIG. 3B) into a left half surface 711 and a right half surface 712 with a vertical virtual line passing through the apex on the optical axis X as a dividing line, and individually rotating the half surfaces 711 and 712 backward about the dividing line. In the present exemplary embodiments, the half surfaces 711 and 712 are rotated by 0.24° each.

As shown in FIG. 4A, the second projector lens 8 on the front side can include a rear surface (incident surface) 81 which can have a function of vertically widening the light source image.

As shown in FIG. 4B, the rear surface 81 of the second projector lens 8 can be a surface formed by dividing a basic shape that is a smooth continuous surface (shape shown by the long dashed double-short dashed line in FIG. 4B) into an upper half surface 811 and a lower half surface 812 with a lateral virtual line passing through the apex on the optical axis X as a dividing line, and individually rotating the half surfaces 811 and 812 forward about the dividing line. In the present exemplary embodiment, the half surfaces 811 and 812 are rotated by 0.24° each.

Next, a projection image (light distribution pattern) formed by the vehicle lighting fixture 1 will be described.

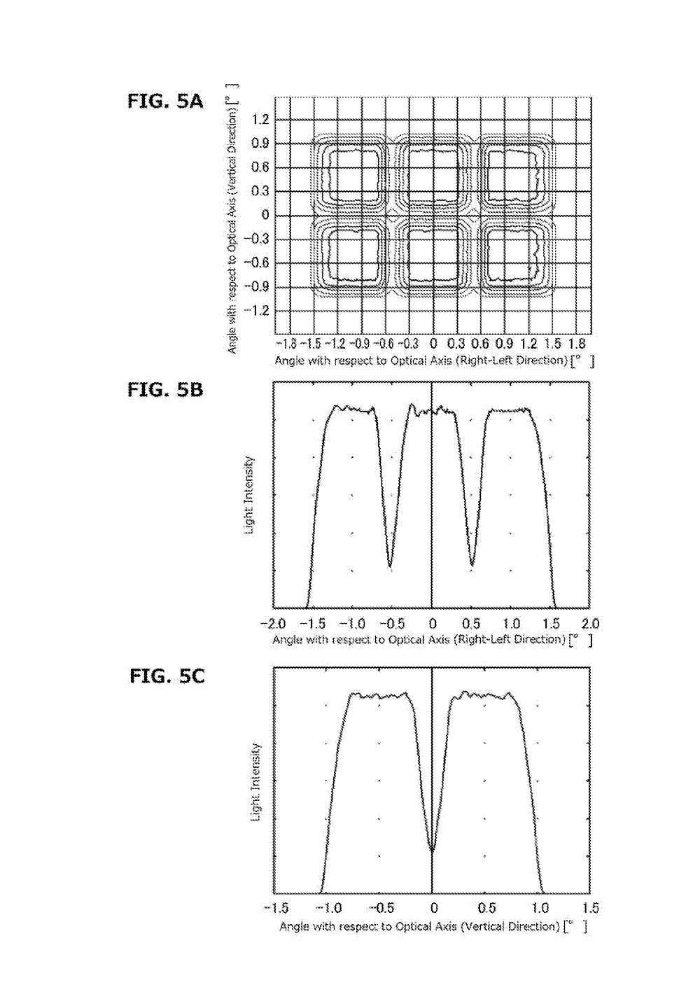

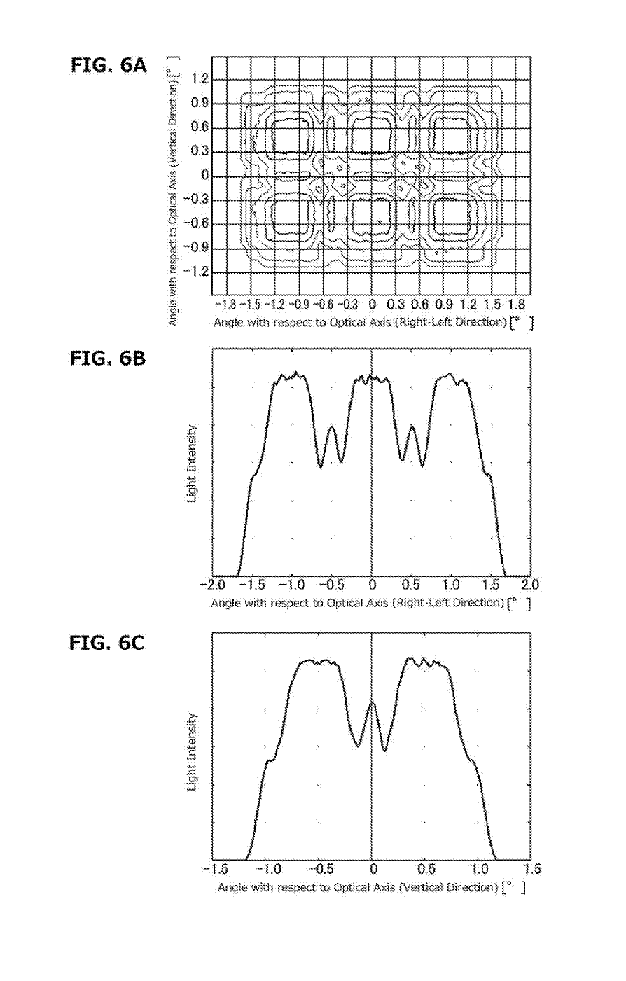

FIGS. 5A to 5C and 6A to 6C are graphs showing light intensity distributions of projection images formed on a virtual screen approximately 25 m away from the vehicle lighting fixture 1 when the two projector lenses 7 and 8 have the basic shapes (as a comparative example in FIGS. 5A to 5C) and when the two projector lenses 7 and 8 have the shapes of the present exemplary embodiment (FIGS. 6A to 6C). FIGS. 5A and 6A are light intensity distribution charts of the projection images on the virtual screen. FIGS. 5B and 6B are light intensity distribution charts in the left-right direction of the projection images in a −0.5° position below the optical axis X (vertically −0.5° position). FIGS. 5C and 6C are light intensity distribution charts in the vertical direction of the projection images in a lateral position through the optical axis X (laterally 0° position).

In the vehicle lighting fixture 1, the light emitted forward from the plurality of LED elements 21 of the LED array 2 can be projected forward by the two projector lenses 7 and 8 to form a predetermined projection image (light distribution pattern) in front of the lamp. The projection image formed here is a light source image changed by the front or rear surfaces of the two projector lenses 7 and 8.

If the two projector lenses 7 and 8 have the basic shapes (i.e., the front or rear surfaces of the two projector lenses 7 and 8 are not divided or rotated), as shown in FIGS. 5A to 5C, a projection image simply corresponding to the arrangement of the plurality of LED elements 21 is formed. In other words, the formed projection image has light intensity variations, where the gaps between the plurality of LED elements are reflected as extremely dark portions.

In the vehicle lighting fixture 1 according to the present exemplary embodiment, the front or rear surfaces of the two projector lenses 7 and 8 can be laterally or vertically divided and rotated. The light source image can thus be laterally and vertically widened by the two projector lenses 7 and 8, respectively. Specifically, the front surface 71 of the first projector lens 7 can laterally widen the light source image. The rear surface 81 of the second projector lens 8 can vertically widen the light source image.

As shown in FIGS. 6A to 6C, the projection image formed in front can include dark portions corresponding to the gaps between the plurality of LED elements 21. However, the projection image has shallower valleys of dark portions (i.e., the dark portions have higher light intensity) and light intensity variations can be suppressed as compared to when the front or rear surfaces of the two projector lenses 7 and 8 are continuous surfaces (i.e., basic shapes).

As described above, according to the vehicle lighting fixture 1, the front surface 71 of the first projector lens 7 and the rear surface 81 of the second projector lens 8, divided in the arrangement directions of the plurality of LED elements 21 and rotated, can widen the light source image formed by the plurality of LED elements 21.

This can lessen the dark portions corresponding to the gaps between the plurality of LED elements 21 and, by extension, suppress light intensity variations in the light distribution. In addition, the mode of division and the mode of rotation of the front surface 71 of the first projector lens 7 and the rear surface 81 of the second projector lens 8 can be appropriately adjusted for more precise light distribution control.

Consequently, light intensity variations in the light distribution by the plurality of LED elements 21 can be suppressed, and more precise light distribution control can be performed as well.

The plurality of LED elements 21 do not need to be arranged in a matrix in the vertical and left-right directions, and have only to be arranged in a direction or directions orthogonal to light emitting direction of the light source (the optical axis). Thus, the plurality of LED elements 21 may be arranged in an oblique front-rear direction, in only one direction, or in two directions which are not orthogonal to each other.

It will be understood that, in such cases, the front surface 71 of the first projector lens 7 and the rear surface 81 of the second projector lens 8 need to be appropriately divided and rotated so that the light source image can be widened in the arrangement direction(s) of the plurality of LED elements 21.

The number of projector lenses is not limited to two. For example, only one projector lens may be used. Three or more projector lenses may be used.

The surfaces to be divided and rotated to widen the light source image may be at least one of the rear and front surfaces of the projector lenses regardless of the number of projector lenses. That is, the rear surface of the first projector lens 7 or the front surface of the second projector lens 8 may be divided and rotated. Such a surface is desirably one through which light as nearly parallel to the optical axis X as possible passes.

The dividing lines for dividing the front surface 71 and the rear surface 81 of the two projector lenses 7 and 8 do not need to be lines passing through the apexes on the optical axis X. The front and rear surfaces of the two projector lenses 7 and 8 each may be a surface formed by dividing a surface into a plurality of surfaces in an arrangement direction (vertical or left-right direction) of the plurality of LED elements 21 and rotating each of the divided surfaces so that the light source image is widened in the arrangement direction.

Next, a modified example of the foregoing exemplary embodiment will be described. Components similar to those of the foregoing exemplary embodiment will be designated by the same reference numerals. A description thereof will be omitted.

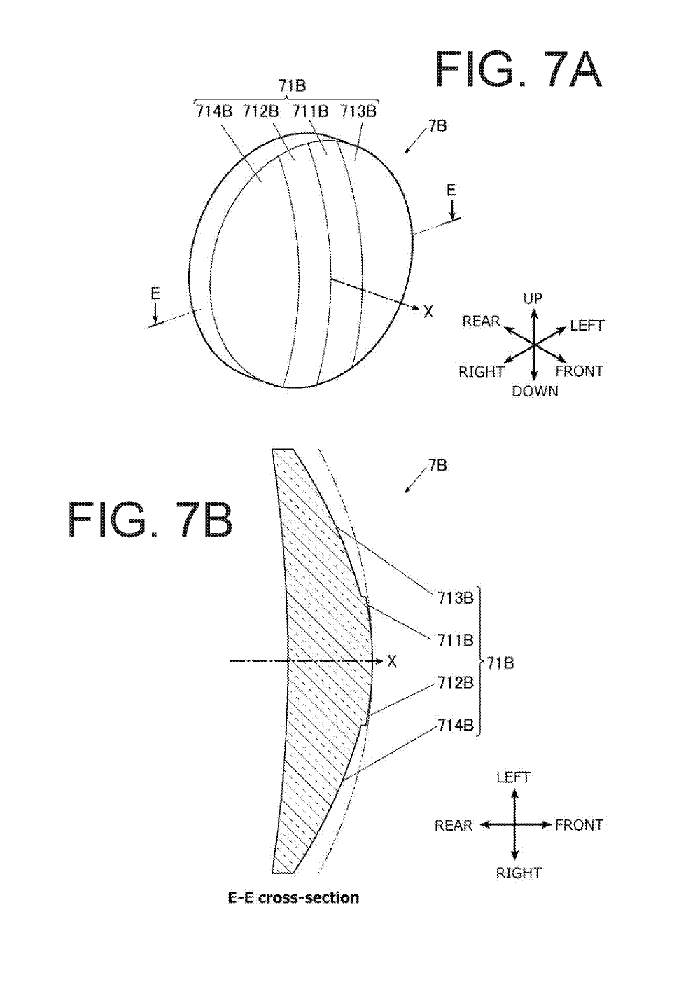

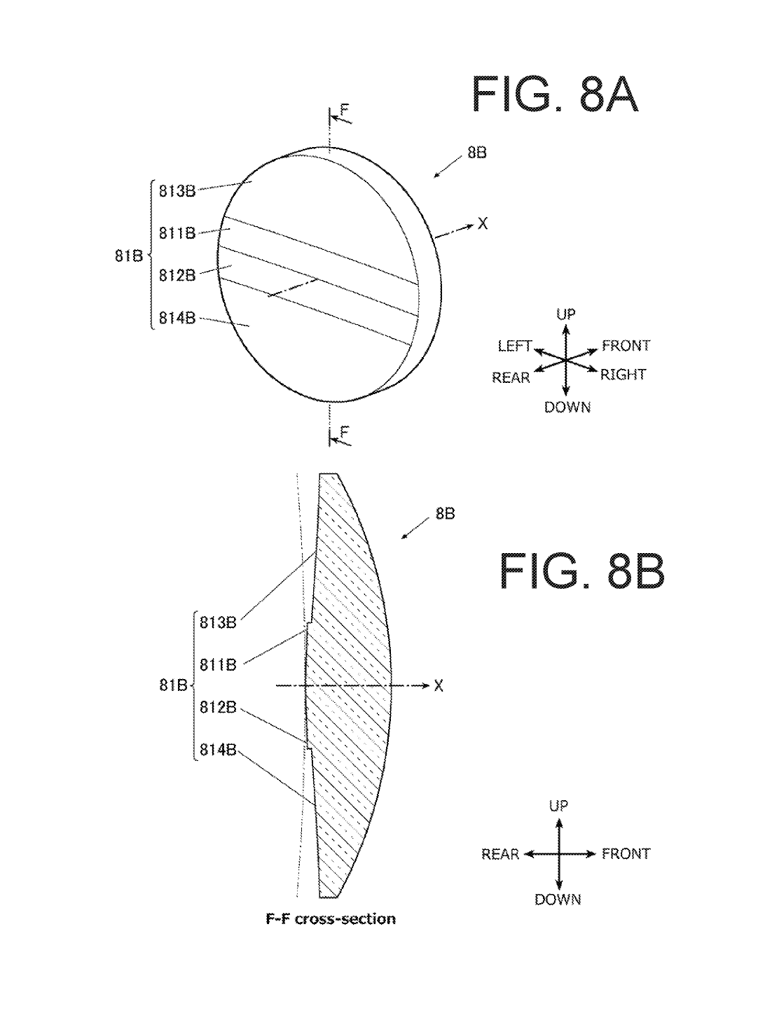

FIG. 1 is a sectional side view showing essential parts of a vehicle lighting fixture 1B according to the present modified example. FIGS. 7A, 7B, 8A, and 8B are diagrams for describing a first projector lens 7B and a second projector lens 8B included in the vehicle lighting fixture 1B. FIGS. 7A and 8A are perspective views. FIGS. 7B and 8B are sectional views taken along the lines E-E and F-F of FIGS. 7A and 8A, respectively. In FIG. 1, the cross section of the second projector lens 8B is shown in a simplified form. A more precise configuration of the cross section is shown in FIG. 8B.

As shown in FIG. 1, the vehicle lighting fixture 1B is different from the vehicle lighting fixture 1 according to the foregoing exemplary embodiment only in that the two projector lenses 7B and 8B are included in place of the two projector lenses 7 and 8.

Of the two projector lenses 7B and 8B, as shown in FIG. 7A, the first projector lens 7B is different from the first projector lens 7 according to the foregoing exemplary embodiment in that its front surface 71B is divided in four.

The front surface 71B of the first projector lens 7B can be laterally divided into four surfaces, including a left inner surface 711B, a right inner surface 712B, a left outer surface 713B, and a right outer surface 714B. The left and right inner surfaces 711B and 712B can be bordered by a lateral center line passing through the apex on the optical axis X. The left and right outer surfaces 713B and 714B can be located on the outer sides of the left and right inner surfaces 711B and 712B. The front surface 71B can be formed in a laterally symmetrical shape. As shown in FIG. 7B, each of the surfaces can be formed by rotating a corresponding portion of the basic shape (shown by the long dashed double-short dashed line in FIG. 7B) of the first projector lens 7 according to the foregoing exemplary embodiment backward about a vertical virtual line that passes through the apex on the optical axis X.

In the present modified example, the left outer surface 713B and the right outer surface 714B on the outer sides of the front surface 71B of the first projector lens 71B can have a rotation angle approximately three times that of the left inner surface 711B and the right inner surface 712B on the inner side. Specifically, the left inner surface 711B and the right inner surface 712B are rotated by 0.13° each. The left outer surface 713B and the right outer surface 714B are rotated by 0.42° each. The left inner surface 711B and the right inner surface 712B are formed with a width of approximately 7.5 mm each. Such a width dimension can be set so that the light source image can be widened in a desired manner, in consideration of the light distribution characteristics of the LED elements 21. In the present modified example, the width dimension can be set so that the light source image can be widened almost linearly, in consideration of the Lambertian characteristic of the LED elements 21.

As shown in FIG. 8A, the second projector lens 8B is different from the second projector lens 8 according to the foregoing exemplary embodiment in that its rear surface 81B is divided in four.

The rear surface 81B of the second projector lens 8B can be vertically divided into four surfaces, including an upper inner surface 811B, a lower inner surface 812B, an upper outer surface 813B, and a lower outer surface 814B. The upper and lower inner surfaces 811B and 812B can be bordered by a vertical center line passing through the apex on the optical axis X. The upper and lower outer surfaces 813B and 814B can be located on the outer sides of the upper and lower inner surfaces 811B and 812B. The rear surface 81B can be formed in a vertically symmetrical shape. As shown in FIG. 8B, each of the surfaces can be formed by rotating a corresponding portion of the basic shape (shown by the long dashed double-short dashed line in FIG. 8B) of the second projector lens 8 according to the foregoing exemplary embodiment forward about a lateral virtual line that passes through the apex on the optical axis X.

In the present exemplary embodiment, the upper outer surface 813B and the lower outer surface 814B on the outer sides of the rear surface 81B of the second projector lens 8B can have a rotation angle approximately three times that of the upper inner surface 811B and the lower inner surface 812B on the inner side. Specifically, the upper inner surface 811B and the lower inner surface 812B are rotated by 0.13° each. The upper outer surface 813B and the lower outer surface 814B are rotated by 0.42°. The upper inner surface 811B and the lower inner surface 812B are formed with a width of approximately 7.5 mm each. Like the left inner surface 711B and the right inner surface 712B of the front surface 71B of the first projector lens 7B, the width dimension can be set so that the light source image is widened in a desired manner, in consideration of the light distribution characteristics of the LED elements 21.

Next, a projection image (light distribution pattern) formed by the vehicle lighting fixture 1 will be described.

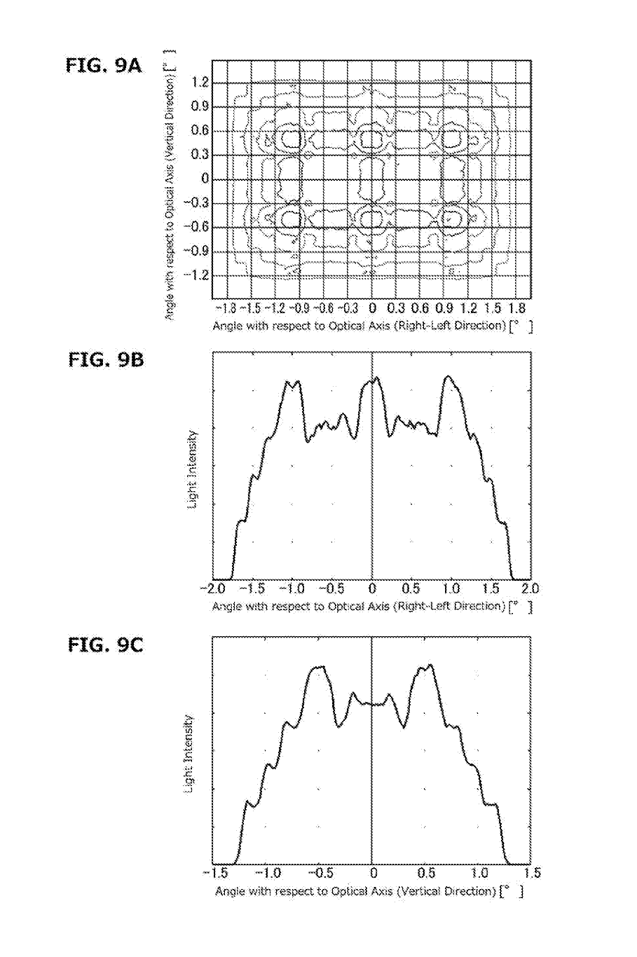

FIGS. 9A to 9C are graphs showing a light intensity distribution of a projection image formed on a virtual screen approximately 25 m away from the front portion of the vehicle lighting fixture 1B. FIG. 9A is a light intensity distribution chart of the projection image on the virtual screen. FIG. 9B is a light intensity distribution chart in the left-right direction of the projection image in a −0.5° position below the optical axis X (vertically −0.5° position). FIG. 9C is a light intensity distribution chart in the vertical direction of the projection image in the left-right direction passing through the optical axis X (laterally 0° position).

In the vehicle lighting fixture 1B, the light emitted forward from the plurality of LED elements 21 of the LED array 2 can be projected forward by the two projector lenses 7B and 8B to form a predetermined projection image (light distribution pattern) in front of the lamp.

Like the foregoing exemplary embodiment, the projection image formed here can be obtained by vertically and laterally widening the light source image by the divided and rotated front surface 71B and rear surface 81B of the two projector lenses 7B and 8B. Light intensity variations of the entire projection image can thus be suppressed.

In the two projector lenses 7B and 8B according to the present modified example, two types of divided surfaces having different rotation angles can be formed on the front surface 71B and the rear surface 81B. Specifically, the front surface 71B of the first projector lens 7B can be divided into the left and right inner side surfaces 711B and 712B and the left and right outer surfaces 713B and 714B which have different rotation angles. The rear surface 81B of the second projector lenses 8B can be divided into the upper and lower inner surfaces 811B and 812B and the upper and lower outer surfaces 813B and 814B which have different rotation angles.

The two types of divided surfaces can magnify the light source image by different degrees. As shown in FIGS. 9A to 9C, the projection image formed forward therefore has shallower valleys of dark portions (i.e., the dark portions have higher luminous intensities) corresponding to the gaps between the plurality of LED elements 21 and light intensity variations are further suppressed as compared to that of the foregoing exemplary embodiment shown in FIG. 6 (where the divided surfaces of the projector lenses have one type of rotation angle).

Of the two types of divided surfaces formed on the front surface 71B and the rear surface 81B of the two projector lenses 7B and 8B according to the present modified example, the outer divided surfaces can be configured to have a rotation angle approximately three times that of the inner divided surfaces.

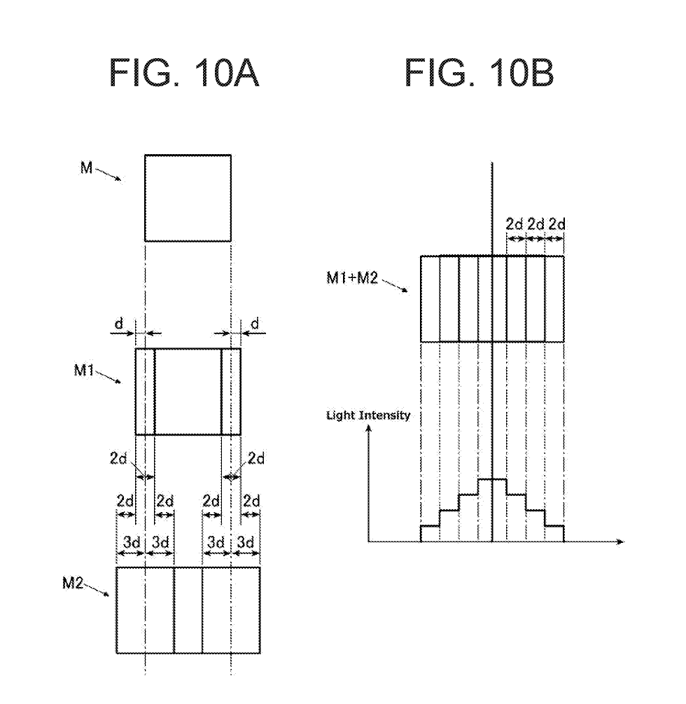

As shown in FIG. 10A, suppose that an original light source image M is shifted to both sides by d by the inner divided surfaces to form a light source image Ml. A light source image M2 formed by the outer divided surfaces can then be shifted to both sides by 3d.

The formed projection image is the superposition of the light source image M1 and the light source image M2. As shown in FIG. 10B, the formed projection image can thus have a light intensity distribution that changes stepwise at regular intervals. In other words, a projection image of which the light intensity changes smoothly in the shift direction of the light source image M can be obtained.

As described above, according to the vehicle lighting fixture 1B, two types of divided surfaces having different rotation angles can be formed on the front surface 71B of the first projector lens 7B and the rear surface 81B of the second projector lens 8B.

Since the two types of divided surfaces can magnify the light source image by different degrees, light intensity variations of the formed projection image can be more suppressed than in the foregoing exemplary embodiment. That is, light intensity variations in the light distribution by the plurality of LED elements 21 can be further suppressed.

The outer divided surfaces of the front surface 71B and the rear surface 81B of the projector lenses 7B and 8B can have the rotation angle approximately three times that of the inner divided surfaces. This can provide a projection image of which the light intensity changes smoothly in the shift direction of the light source image.

The same effects can be obtained if the inner divided surfaces are configured to have a rotation angle three times that of the outer divided surfaces.

Exemplary embodiments to which the presently disclosed subject matter can be applied are not limited to the foregoing exemplary embodiment or the modified example thereof. Appropriate modified examples may be made without departing from the gist of the presently disclosed subject matter.

For example, in another modified example of the foregoing exemplary embodiment, the number of types of divided surfaces on the front or rear surfaces of the two projector lenses 7B and 8B is not limited in particular. The front or rear surfaces of the two projector lenses 7B and 8B may include three or more types of divided surfaces.

The vehicle lighting fixture according to the presently disclosed subject matter can also be widely applied to vehicle lighting fixtures other than a headlamp.

It will be apparent to those skilled in the art that various modified examples and variations can be made in the presently disclosed subject matter without departing from the spirit or scope of the presently disclosed subject matter. Thus, it is intended that the presently disclosed subject matter cover the modified examples and variations of the presently disclosed subject matter provided they come within the scope of the appended claims and their equivalents. All related art references described above are hereby incorporated in their entirety by reference.

What is claimed is:

1. A vehicle lighting fixture, having an optical axis in which light is emitted therefrom, comprising:
a plurality of light sources arranged in a predetermined arrangement direction orthogonal to the optical axis; and
at least one projector lens that is arranged forward of the plurality of light sources along the optical axis and is configured to project light emitted from the plurality of light sources forward, wherein
the at least one projector lens includes a rear surface and a front surface at least either one of which can be a surface formed by dividing a basic shape into a plurality of divided surfaces corresponding to the arrangement direction and rotating each of the divided surfaces so that a light source image formed by the plurality of light sources can be widened corresponding to the arrangement direction, the basic shape being a smooth continuous surface.

2. The vehicle lighting fixture according to claim 1, wherein the at least one surface is divided into a plurality of divided surfaces with a line orthogonal to a direction corresponding to the arrangement direction in the optical axis, the line passing through a center of the surface, as a dividing line, and each of the divided surfaces is rotated about the dividing line.

3. The vehicle lighting fixture according to claim 1, wherein the at least one surface includes a plurality of types of divided surfaces having respective different rotation angles.

4. The vehicle lighting fixture according to claim 2, wherein the at least one surface includes a plurality of types of divided surfaces having respective different rotation angles.

5. The vehicle lighting fixture according to claim 3, wherein the at least one surface includes two types of divided surfaces that are an inner side and an outer side of the at least one surface, and either one of the two types of divided surfaces has a rotation angle approximately three times that of the other divided surface.

6. The vehicle lighting fixture according to claim 4, wherein the at least one surface includes two types of divided surfaces that are an inner side and an outer side of the at least one surface, and either one of the two types of divided surfaces has a rotation angle approximately three times that of the other divided surface.

7. The vehicle lighting fixture according to claim 1, wherein:
the plurality of light sources are arranged in a matrix in two arrangement directions generally orthogonal to each other;
the at least one projector lens includes at least two projector lenses that are juxtaposed in the optical axis; and
the front surface of a projector lens on a rear side is formed to correspond to one of the two arrangement directions, and the rear surface of a projector lens on a front side is formed to correspond to the other of the two arrangement directions.

8. The vehicle lighting fixture according to claim 2, wherein:
the plurality of light sources are arranged in a matrix in two arrangement directions generally orthogonal to each other;
the at least one projector lens includes at least two projector lenses that are juxtaposed in the optical axis; and
the front surface of a projector lens on a rear side is formed to correspond to one of the two arrangement directions, and the rear surface of a projector lens on a front side is formed to correspond to the other of the two arrangement directions.

9. The vehicle lighting fixture according to claim 3, wherein:
the plurality of light sources are arranged in a matrix in two arrangement directions generally orthogonal to each other;
the at least one projector lens includes at least two projector lenses that are juxtaposed in the optical axis; and
the front surface of a projector lens on a rear side is formed to correspond to one of the two arrangement directions, and the rear surface of a projector lens on a front side is formed to correspond to the other of the two arrangement directions.

10. The vehicle lighting fixture according to claim 4, wherein:
the plurality of light sources are arranged in a matrix in two arrangement directions generally orthogonal to each other;
the at least one projector lens includes at least two projector lenses that are juxtaposed in the optical axis; and
the front surface of a projector lens on a rear side is formed to correspond to one of the two arrangement directions, and the rear surface of a projector lens on a front side is formed to correspond to the other of the two arrangement directions.

11. The vehicle lighting fixture according to claim 5, wherein:
the plurality of light sources are arranged in a matrix in two arrangement directions generally orthogonal to each other;
the at least one projector lens includes at least two projector lenses that are juxtaposed in the optical axis; and
the front surface of a projector lens on a rear side is formed to correspond to one of the two arrangement directions, and the rear surface of a projector lens on a front side is formed to correspond to the other of the two arrangement directions.

12. The vehicle lighting fixture according to claim 6, wherein:
the plurality of light sources are arranged in a matrix in two arrangement directions generally orthogonal to each other;
the at least one projector lens includes at least two projector lenses that are juxtaposed in the optical axis; and
the front surface of a projector lens on a rear side is formed to correspond to one of the two arrangement directions, and the rear surface of a projector lens on a front side is formed to correspond to the other of the two arrangement directions.
